(19) United States
(12) Patent Application Publication
(10) Pub. No.: US 2004/0081138 A1
(43) Pub. Date: Apr. 29, 2004

(54) Method for associating subscriber numbers to messenger services

(76) Inventor: Arto Nevala, Oulu (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/415,744

(22) PCT Filed: Oct. 26, 2001
(86) PCT No.: PCT/FI01/00932

(30) Foreign Application Priority Data
Nov. 3, 2000 (FI) 20002420

(51) Int. Cl. H04L 12/66

(52) U.S. Cl. 370/352; 370/395.2

(57) ABSTRACT

The invention enables using packet-switched network services, such as messenger services of Internet, through a subscriber connection belonging to some circuit-switched network. A subscriber can associate by phone a desired subscriber connection to a desired messenger service. This is termed “association”. When association is initiated the desired subscriber connection can be reached from the Internet. Thus users of IP workstations can reach PSTN, ISDN and mobile subscriber connections through the messenger service by clicking the mouse. Also PSTN, ISDN and mobile subscribers may reach each other, and users of IP workstations through the messenger service. In this case, the subscribers must have an Internet connection. The invention is based on a new, messenger Access Control Point (MACP) named control point of PST network. The MACP has two basic tasks. First, it executes association, in other words, it enables a connection between a messenger service and a subscriber connection. Secondly, it routes a call, or data, to gateway when some person or service tries to connect the subscriber connection via a messenger service. Then the gateway route the call or data to the desired subscriber connection. The MACP operates as a logical bridge between the packed switched networks and the circuit-switched networks.

### FIELD OF THE INVENTION

The present invention generally relates to the packet-switched networks such as the Internet, messenger services of the Internet, and to connections between the packet-switched networks and the circuit-switched networks.

### BACKGROUND OF THE INVENTION

Over the past several years the Internet has become exceedingly popular in advanced industrialized societies. The Internet contains a world of information and techniques to explore it. The basic techniques for exploring information are search robots and portals, and, of course, hypertext links of the HTML language.

The Internet contains services that enable a user to access information and to interact with other users of the Internet. By writing and reading the texts of others, Internet users can chat with one another. Discussion groups deal with certain topics such as economics, fashion, and sport. Some online information services offer real-time stock prices. Voting by Internet may be a practical way to make decisions, for example, when it is difficult to organize a meeting.

The public switched telephone network (PSTN) is a circuit-switched network whose terminals are equipped with telephone numbers. The telephone number may consist of a land code, an area code, and a subscriber number. For example, the telephone number 358 9 123456 consists of Finland's land code 358, area code 9, and subscriber number 123456. When the number 358 9 123456 is called, the PSTN exchanges route the call according to the land code and the area code. If the receiver answers, a circuit is allocated for the caller and the receiver.

The Internet network is a packet-switched network whose terminals are equipped with an IP address. Each IP address consists of four numbers between 1 and 255, with dots separating each number; for example, 130.237.21.10. The first number refers to the topmost network level, the second number refers to the next network level, etc. Routers of the Internet network locate the correct receiver by its IP address. Since the Internet is a packet-switched network, no circuit is allocated for the connection. Instead, data is transmitted in packets from the sender to the receiver, and packets of other connections may be transmitted in the same circuit.

A gateway is an apparatus that converts and transmits data between networks. The gateway between the Internet and the PSTN converts packet-switched data to circuit-switched data and vice versa. This enables speech and data transmission between the Internet and the PSTN.

The integrated service digital network (ISDN) is principally a circuit switched network like the PSTN network. The ISDN offers for subscribers a higher transmission capacity than the PSTN. An asymmetrical digital subscriber line (ADSL) represents a technique which enables even more fast data connections than the ISDN. The public land mobile network (PLMN) or mobile network in short, is based on the utilization of radio frequencies. Mobile phones, including WAP phones, offer mobility in telecommunication. The gateway can route calls not only to PSTN numbers, but also to ISDN or ADSL numbers, or to mobile phone numbers.

A service named voice-over-IP enables calls from the PSTN to the Internet. Thus a PSTN subscriber can make a phone call to an IP workstation and talk with its user, providing that the IP workstation is equipped with a microphone and loudspeakers. Also a user of the IP workstation can call a PSTN subscriber, and the PSTN subscriber may receive the call by using the conventional telephone set, or by using a computer equipped with a modem, a microphone, and loudspeakers.

Messenger services are Internet services. There is no specific definition for messenger services. They offer, for example, short messages between Internet users, discussions groups, online information service, and voting. The most popular messenger services are probably chatting and dating services. Users of messenger services are reachable by clicking some symbol, such as a nickname, on the screen.

A messenger service has interface for inputting connection information and said another user information, and each user has a user name and a secret key for preventing misuse of his or her information. The user information is stored in a catalog of the messenger service. The users are reachable via the messenger service by using the catalog.

A subscriber may use a computer and a modem and input his or her name, phone number, etc. through the interface of the messenger service. The Internet is a suitable medium for this kind of registration operation, or for some other operation requiring quite a lot of guideline texts and information input. However, subscribers may feel more comfortable carrying out some operations by means of a telephone or a mobile phone rather than by using a computer equipped with Internet connection.

The drawback in prior art is that subscribers cannot control messenger services by phone.

Certainly it is possible that a PSTN operator employs staff to receive subscribers' calls. Then a subscriber can tell his or her phone number and some information, such as age and sex and nickname, and the staff inputs the information, for example, through Internet interface, to a messenger service. Since this kind of service is not automated, it may be slow and expensive to use.

The Internet is nowadays a worldwide popular network. However, in the future it might be replaced at least partly by some other networks. The present invention generally concerns packet-switched network, not only the Internet although some services are as yet available purely in the Internet.

The first objective of the invention is to enable calls via the messenger service to a subscriber so that the subscriber does not necessarily have to use the packet-switched network.

A dating service is an example of a messenger service whose participants usually want to remain anonymous. When needed, the messenger service should hide the subscriber numbers from its users.

The second objective of the invention is to enable calls via a messenger service to subscribers, without disclosing their phone numbers.

Probably most subscribers prefer to use a telephone or mobile phone when they want to associate a desired phone number to a desired messenger service. This operation is termed “association”, and it is executed in prior art by inputting a phone number through the Internet interface. A subscriber number is reachable only via those messenger services to which the subscriber number is associated.

The third objective of the invention is to enable the association of a desired phone number to a messenger service by phone.

A subscriber may not be able or not interested in receiving calls from a messenger service all the time. Therefore a subscriber may be given the possibility of dissociating a phone number from the messenger service. This operation is termed “dissociation”, and it is executed in prior art through the Internet interface. Alternatively, the association may last for only a predetermined time period, for example, for one hour whereby the dissociation operation is not needed.

The fourth objective of the invention is to enable the setting of an association period for a messenger service by phone, or to enable the dissociation of a phone number from a messenger service by phone.

The Internet pages of messenger services include hypertext links that can be clicked by mouse. Of course, there is also some other visible information on the screen. In addition, a messenger service may include non-visible confidential user information.

The fifth objective of the invention is to enable transmitting information, such as nicknames or credit card number, to a messenger service by phone.

### SUMMARY OF THE INVENTION

Briefly, the invention enables the use of Internet services, such as messenger services, through a subscriber connection belonging to some other network than the Internet. Or more generally, the invention enables use of packet-switched network services through a subscriber connection belonging to some circuit-switched network.

Many subscribers prefer to use a telephone or mobile phone when they want to associate a phone number to a messenger service. One main objective of the invention is to enable the association of a phone number to a messenger service by phone. The phone number, or in other words, the subscriber number, may be a PSTN or ISDN number, a mobile phone number, or a WAP number.

The main objective of the invention is achieved by means of a new control point in the PSTN network. That control point is named messenger Access Control Point (MACP).

The MACP has two important tasks. First, it sets up the association of the subscriber number to a desired messenger service. When a subscriber calls the MACP service and associates the subscriber number to some messenger service, the MACP maps the subscriber number to a number which is termed “association numbers”. Then the MACP stores the pair, consisting of the subscriber number and the association number, in its catalogue. Finally, the MACP sends the association number to the messenger service, which stores the association number in its own catalog.

Secondly, the MACP routes a call arriving from the packet-switched network such as the Internet to a gateway when some person or service tries to connect the subscriber number via a messenger service.

To connect a call, each messenger service communicates with the MACP by sending the association number. Using the association number as a search key, the MACP fetches the stored pair in its catalog, and the stored pair includes the subscriber number. Then the MACP transfers the subscriber number to the gateway, so that the gateway can route the incoming call to the subscriber number. Thus, the MACP operates as a logical bridge between the PSTN and the packet-switched network such as the Internet and enables calls from the packet-switched network to a PSTN number or a number of some other circuit-switched network. The MACP has a user interface with recorded announcements through which the subscriber can associate a subscriber number to some desired messenger service, or dissociate the subscriber number from the messenger service.

The MACP has means for transmitting association and dissociation information from a user to the messenger service. The MACP has also a means for routing a call from messenger services to a user.

For mobile users, the MACP has another user interface for receiving short messages. Through this user interface a mobile phone subscriber can associate or dissociate a subscriber number to a certain messenger service. In addition, a mobile phone subscriber can transmit some additional information, such as a nickname, to the MACP.

### BRIEF DESCRIPTION OF THE DRAWINGS

The invention is described more closely with reference to the accompanying drawings, in which

FIG. 1 describes the MACP as a logical bridge between the packet-switched networks and the circuit-switched networks.

FIG. 2 shows an example of a catalog of the MACP and a catalog of a messenger service.

FIG. 3a depicts message transmission for transferring association and dissociation information from the MACP to a messenger service (the first part).

FIG. 3b depicts message transmission for transferring association and dissociation information from the MACP to a messenger service (the latter part).

FIG. 4a depicts message transmission for routing a call from a messenger service, via gateway, to a subscriber number (the first part).

FIG. 4b depicts message transmission for routing a call from a messenger service, via the gateway, to a subscriber number (the latter part).

### DETAILED DESCRIPTION OF THE INVENTION

The invention concerns speech connections, data connections, and short messages. If the subscriber connection used is a mobile phone, the mobile phone subscriber may not only receive speech but also short messages or data. If the subscriber connection used is a computer, the subscriber may receive speech or data.

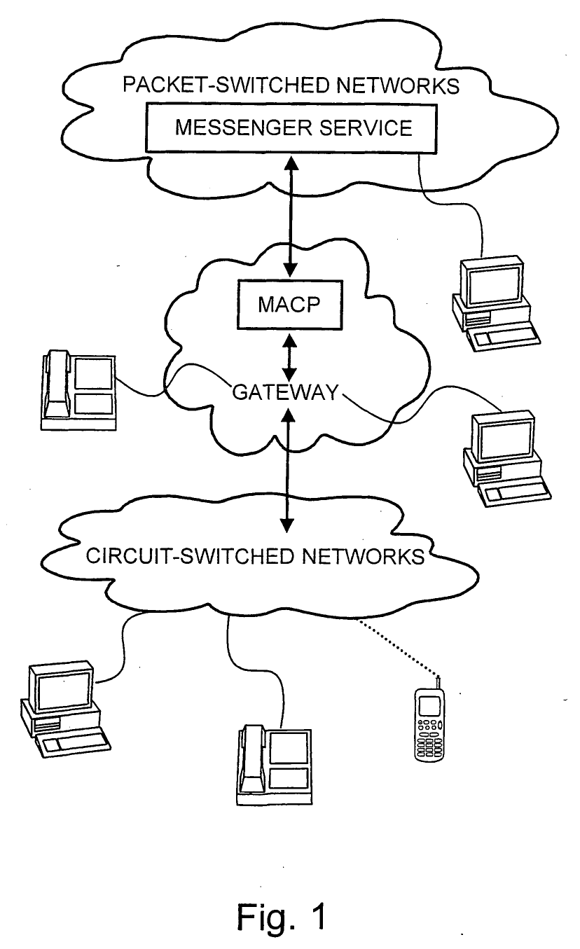

FIG. 1 illustrates networks and some subscriber connections. A subscriber can use a personal computer equipped with a modem, a microphone, and loudspeakers to receive calls or data from a messenger service. On the following, subscriber connections are described in couple of examples. If a subscriber has an ISDN subscriber connection, he or she may receive speech or data and use the Internet simultaneously. Because messenger services are Internet services a subscriber needs an Internet connection in order to call the other users of a messenger service. If a subscriber has a WAP phone or a mobile phone with Internet connections, not only can he or she receive calls but also make calls. In addition to the above examples, several different subscriber connections are possible between services of the packet-switched networks and subscribers of the circuit-switched networks.

In this application “subscriber” refers to a subscriber of any circuit-switched network i.e. anybody or any service which is able to call the PSTN network. Thus a “subscriber” is not necessarily a person; it may also be an automated service. However, a “subscriber” has to be able to call the PSTN network because the MACP locates in the PSTN.

Correspondingly a “phone number”, a “subscriber number”, or the “subscriber's phone number” refers to a number of any circuit-switched network. The term “subscriber number” as used in the claims refers to any kind of subscriber number. The term “data” as used in the claims refers to any data, including speech and short messages, for example.

The MACP shown in FIG. 1 is a new inventive control point of the PSTN network. It comprises the following components:

one or more catalogs and means for handling them; the catalogs are lists of number pairs, each pair consisting of a subscriber number and an association number pairs;

a user interface that comprises service numbers and announcements; subscribers may use this interface to associate or dissociate messenger services,

another user interface for receiving short messages from mobile phone subscribers,

a first message processing means for transferring association or dissociation information from the MACP to a messenger service;

a second message processing means for routing a call received from a messenger service via a gateway to a subscriber number,

The components of the MACP are described in details in same order as listed before.

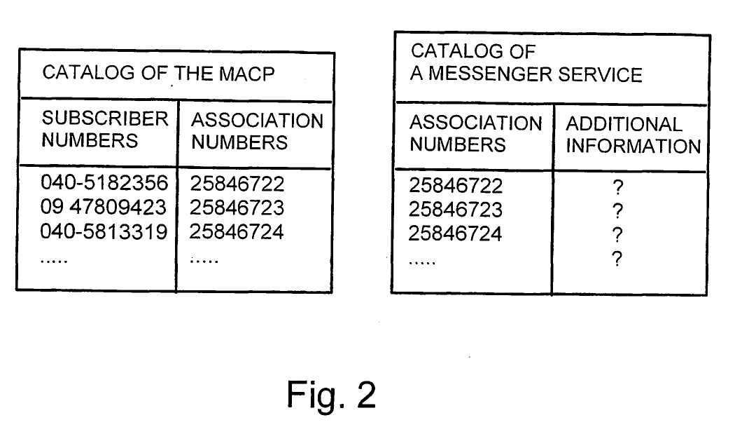

The MACP is equipped one or more catalogs and the means for handling them. In FIG. 2 the MACP is equipped with one catalog.

When a subscriber associates a desired subscriber number to a messenger service, the MACP generates an association number and pairs it with the subscriber number. The MACP adds the pair to its catalog and sends the association number to the messenger service, which adds the association number to its own catalog. The MACP may have one catalog for all messenger services. Alternatively, the MACP may have one catalog per each messenger service.

The association number may be a subscriber number in some presentation form. Because the Internet is not a secure network, the subscriber's number should be sent to the messenger service in an encoded form to prevent its misuse.

However, there is more safety embodiment when the MACP generates an association number that is a sequence number. Then it is not necessary to encode the association number because only the MACP knows to which subscriber number the association number, i.e. the sequence number, is mapped. In this embodiment the messenger services do not acquire subscriber numbers, which also reduces the possibility of misuse of the subscriber numbers.

FIG. 2 illustrates a catalog of the MACP and a catalog of a messenger service. There is, for example, a subscriber number 040-5182356 in the catalog of the MACP. The subscriber number 040-5182356 is mapped to an association number 25846722, which is stored in both the catalogs.

When a subscriber wants to dissociate a subscriber number from a messenger service, the MACP removes the pair consisting of the subscriber number and the association number from its catalog. This disables calls from the messenger service to the subscriber number.

The association may also end automatically after a certain time period. In both cases, the MACP sends the association number to the messenger service, and the messenger service removes the association number from its catalog. For example, a negative association number, which is sent to the messenger service, may indicate dissociation.

A command initiated through a subscriber connection is some type of association, association with additional information, or dissociation. A positive association number indicates association, and a negative association number indicates dissociation. It is also possible to transmit additional information in the command. Thus a subscriber may update his or her information, which is stored in the messenger service.

Generally subscribers may receive calls when end-users of a messenger service call them. However, some messenger services may automatically call all its users. For example, a fictitious messenger service offering sports information operates this way. The MACP then transmits the association number to the messenger service, which adds the association number to its catalog. Occasionally the messenger service passes through its catalog and calls its users in order to mediate sports information. That information may be speech, data, or one or more short messages.

The MACP comprises means for generating the association numbers and handling the catalog. The means execute the simple operations described above, such as, adding and removing pairs, which consists of a subscriber number and an association number, and fetching the pairs.

The MACP comprises the user interface consisting of service numbers and announcements. Through this interface a subscriber can associate and dissociate a desired subscriber number to a desired messenger service. There are several suitable ways to implement the user interface.

For example, it may consist of one service number per messenger service so that a subscriber calls the service number and hears an announcement like: “Please dial ‘1’ to associate Chat World, or dial ‘2’ to dissociate the Chat World”.

The simplest embodiment of the user interface is that a subscriber chooses the messenger service by calling the service number reserved for it, and the desired subscriber number is the calling party number.

It is also possible to use different service numbers for association and dissociation. In that case a subscriber hears an announcement like:

“Welcome to Chat World! You are now associated to the service”. Or a subscriber hears an announcement like: “Thank You! You are now dissociated from the Chat World”.

An association period may be fixed, whereby no dissociation is needed. Or a subscriber may set an association period. In the latter case a subscriber may hear an announcement like: “Please dial a time period for an association. The length of time period may be from one hour to twenty-four hours.”

Thus the basic embodiments to enable different MACP operations are: 1) using a different phone number for different-operations, or 2) using announcements to tell the alternatives to a subscriber. The third embodiment is that the MACP analyzes the subscriber number when it concludes which operation is possible. For example, a mobile phone number begins with a mobile operator prefix which discloses that a subscriber is a mobile phone subscriber. Then the subscriber can send and receive short messages.

By using call diversion it is possible that calls from a messenger service are transferred to some number other than the number from which the association was executed. Another embodiment is that the user interface of the MACP includes an announcement like: “Please dial the phone number that you want to associate to the Chat World”. In this case the associated phone number should be checked in some way before it is accepted. When needed, a user may supply additional information by dialing.

The user interface of the MACP enables a subscriber to initiate association or dissociation by using commands concerning the catalog of the MACP, and via the MACP, the commands also concern the catalog of a messenger service.

The MACP comprises said another user interface for receiving short messages from mobile phone subscribers. Mobile phone subscribers can alternatively use this interface to associate or dissociate messenger services, or they can supply some additional information.

Of course, in many cases people prefer to use an Internet interface of a messenger service because typing is easier by keyboard than by mobile phone keys. On the other hand, if there is only a small amount of information to transmit, people prefer to use a mobile phone because that does not require locating a computer, starting the computer, no taking the Internet connection, etc.

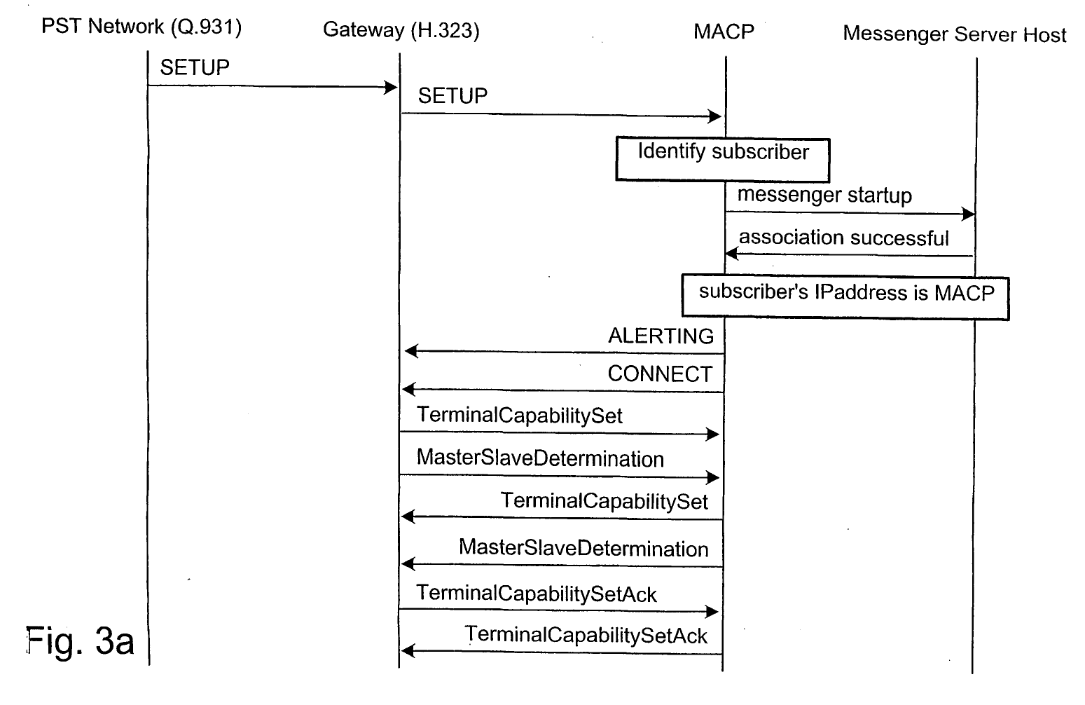

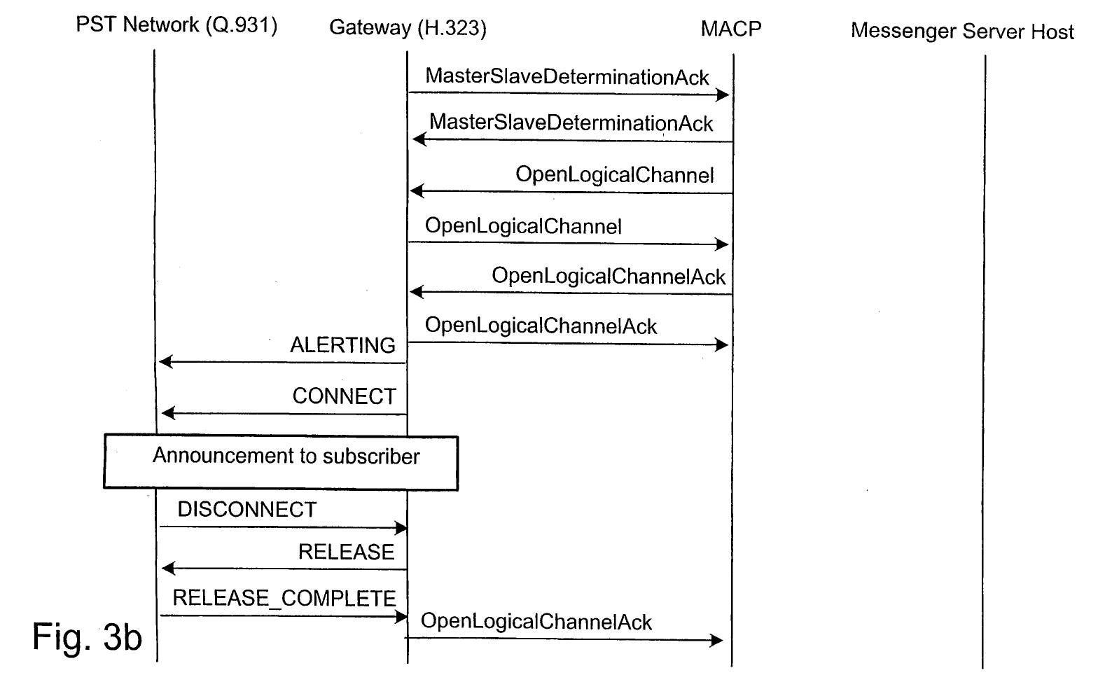

The MACP comprises the first message processing means for transferring association or dissociation information from a subscriber connection, via the gateway and the MACP to a messenger service. The same message processing means can also be used for transmitting additional information, see FIG. 3a and FIG. 3b.

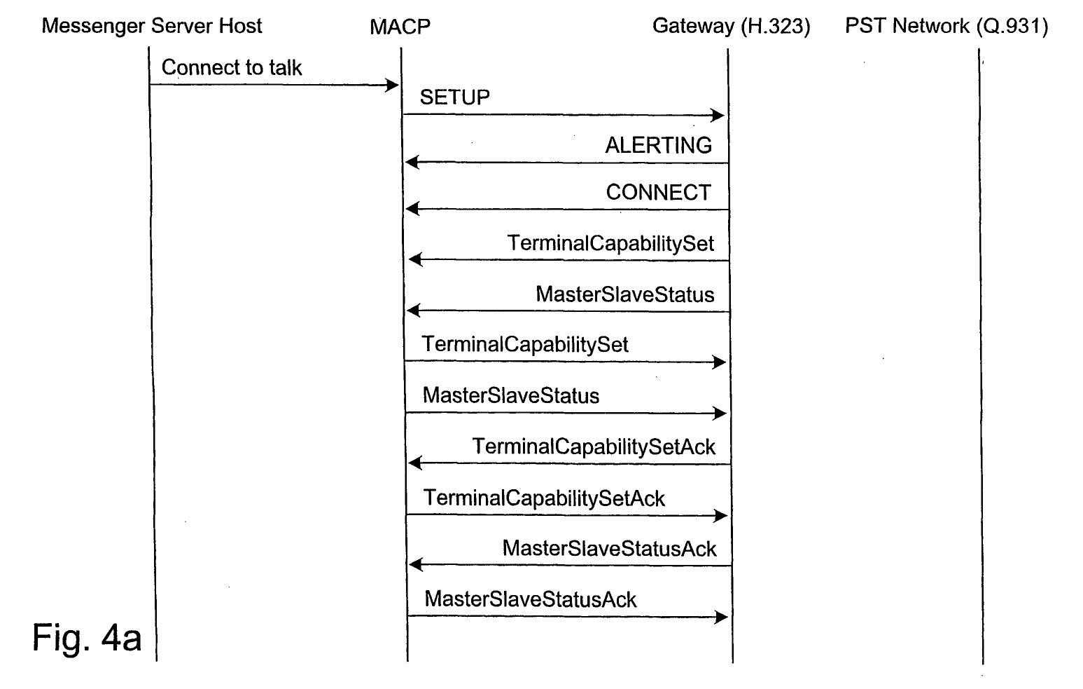

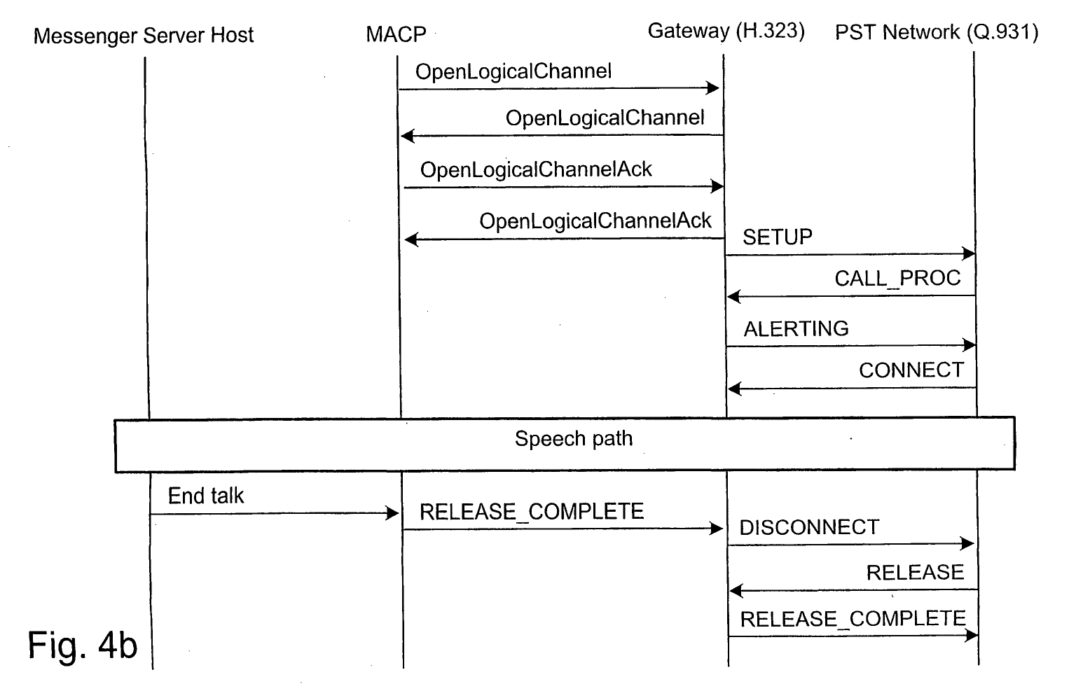

The MACP comprises the second message processing means for routing data from a messenger service, via the MACP and the gateway, to a subscriber connection. In this case, the messenger service first contacts the MACP, see FIG. 4a and FIG. 4b.

Both the message processing means handle Q.931 messages used between the PSTN network and the gateway, as well as H.323 messages used between the gateway and the MACP. Q.931 and H.323 are message protocols specified by ETSI (European Telecommunication Standardization Institute).

In addition, both the message processing means handle messages that are used between the MACP and a messenger server host. Since messages are not standardized, the message names printed in FIGS. 3 and 4 are just examples. However, someone skilled in the art can specify the information content of these messages. Each messenger service may have its own message transmission. The MACP and a messenger service can communicate if they have a common message transmission.

To enable association or dissociation by using short messages, the first message processing means must be adapted so that the MACP communicates with the PLM network instead of the PST network. In addition, to enable the sending of short messages to a subscriber connection, the second message processing means must be adapted to receive data from the messenger service and relocate the data to at least one short message.

1. A method for using packet-switched network services through subscriber connections belonging to circuit-switched networks,
characterized by the steps of:
arranging a control point having at least one service number for receiving commands from the subscriber connections; and
in the control point,
executing an association in response to a command sent from a subscriber connection, wherein a desired packet-switched network service and a desired subscriber connection with a certain subscriber number are associated by
generating an association number, mapping said subscriber number to the association number, and storing said subscriber number and the association number, and
transmitting the association number to the packet-switched network service;
as a result of the association, data transfer from the packet-switched network service to the subscriber connection is enabled; and
when the packet-switched network service contacts by transmitting the association number to the control point,
in the control point,
fetching the subscriber number which is mapped to the association number, and
routing data from the packet-switched network service to the subscriber number fetched.

2. A method as defined in claim 1, characterized by the further steps of:
in the control point,
executing a dissociation, wherein the subscriber connection with the subscriber number is dissociated from the packet-switched network service by
fetching the association number which is mapped to the subscriber number, and
transmitting the association number to the packet-switched network service;
as a result of the dissociation, data transfer from the packet-switched network service to the subscriber connection is disabled.

3. A method as defined in claim 2, characterized in that the dissociation is executed by the control point after a certain time period has elapsed since the association is executed.

4. A method as defined in claim 3, characterized in that the time period is set through the subscriber connection.

5. A method as defined in claim 2, characterized in that the dissociation is executed in response to a command sent from the subscriber connection.

6. A method as defined in claim 1 or 5, characterized in that the command is initiated by a call.

7. A method as defined in claim 1 or 5, characterized in that the command is initiated by sending at least one short message.

8. A method as defined in claim 6 or 7, characterized in that, when the command is initiated, additional information is supplied to the control point which transmits the additional information to the packet-switched network service.

9. A method as defined in claim 1, characterized in that the data routed to the subscriber connection is from an end-user of the packet-switched network service.

10. A method as defined in claim 1, characterized in that the data routed to the subscriber connection is from the packet-switched network service, which operates automatically.

11. A method as defined in claim 1, characterized in that the data routed to the subscriber connection is speech and the connection to the subscriber connection is a speech connection.

12. A control point in a telecommunication network for using packet-switched network services through subscriber connections belonging to circuit-switched networks,
characterized in that the control point comprises:
for purpose of association, wherein a desired packet-switched network service and a desired subscriber connection with a certain subscriber number are associated, and data transfer from the internet service to the subscriber connection is enabled,
a user interface equipped with at least one service number,
first message processing means for receiving commands from the subscriber connection through the user interface, for transmitting an association number to the packet-switched network service, and for transmitting additional information from the subscriber connection to the packet-switched network service,
means for generating an association number, means for mapping the subscriber number to the association number, and a catalog for storing the subscriber number and the association number; and
for a transaction in which the packet-switched network service contacts by transmitting the association number to the control point,
means for fetching the subscriber number from the catalog by using the association number as a search key, and
second message processing means for receiving the association number from the packet-switched network service, and for routing the data from the packet-switched network service towards the subscriber connection having the subscriber number.

13. A control point in a telecommunication network as defined in claim 12, characterized in that the user interface is equipped with means for playing announcements.

14. A control point in a telecommunication network as defined in claim 12, characterized in that the control point further comprises:
for purpose of dissociation, wherein a desired packet-switched network service and a desired subscriber connection with a certain subscriber number are dissociated, and data transfer from the internet service to the subscriber connection is thus disabled,
means for fetching the association number from the catalog by using the subscriber number as a search key, and means for deleting the association number and the subscriber number from the catalog, and
the first message processing means are adapted to inform the packet-switched network service of the dissociation.

15. A control point in a telecommunication network as defined in claim 14, characterized in that the control point further comprises:
another user interface equipped with means for receiving short messages to at least one service number and means for interpreting commands sent within the short messages.

16. A control point in a telecommunication network as defined in claim 15, characterized in that
the first message processing means are adapted to receive at least one short message from the subscriber connection,
the second message processing means are adapted to receive the association number from the packet-switched network service and to route the data from the packet-switched network service in at least one short message to the subscriber connection.

17. A control point in a telecommunication network as defined in claim 14 or 16, characterized in that the control point is adapted to execute the dissociation after a certain time period has elapsed since the execution of the association.

18. A control point in a telecommunication network as defined in claim 17, characterized in that the control point is adapted to receive the length of the time period from the subscriber connection.

19. A control point in a telecommunication network as defined in claim 14 or 16, characterized in that the control point is adapted to execute the dissociation in response to a command initiated from the subscriber connection.

20. A control point in a telecommunication network as defined in claim 12 or 14, characterized in that the command is initiated by a call.

21. A control point in a telecommunication network as defined in claim 12 or 14, characterized in that the command is initiated by sending at least one short message.
